(19) United States
(12) Patent Application Publication
(10) Pub. No.: US 2017/0150764 A1
(43) Pub. Date: Jun. 1, 2017

(54) SYSTEM AND METHOD FOR REMOTE TAILORING

(71) Applicant: Graziano Meloni, Brooklyn, NY (US)

(72) Inventor: Graziano Meloni, Brooklyn, NY (US)

(21) Appl. No.: 14/956,380

(22) Filed: Dec. 1, 2015

(51) Int. Cl. A41H 1/10; A41D 1/02; A41H 1/02; G06T 7/00

(52) U.S. Cl. CPC A41H 1/10; G06T 7/0004; A41D 1/02; A41H 1/02; G06T 2207/30196; G06T 2207/30124; G06T 2210/16

(57) ABSTRACT

The invention is a system and method of remote tailoring including the steps of placing a fitting jacket onto a client, the fitting jacket including a torso and sleeves, the fitting jacket further including a plurality of adjustment features; adjusting one or more of the adjustment features; producing a digital image of the client wearing the fitting jacket; and submitting the digital image to a system app which functions to use image analysis to obtain body measurements for use by a remote tailor.

### FIELD OF THE INVENTION

The present invention relates to a system and method for remotely conducting a tailoring project and, in particular, to a method of remotely custom tailoring high end, upper body and lower body clothing.

### BACKGROUND OF THE INVENTION

The average male customer desiring to obtain a suit or a dress shirt may have an option to buy clothing “off the rack.” While this option may present the customer with a reasonable selection of clothing in multiple retail establishments, off-the-rack clothing does not have the fit and quality that can be obtained by personally patronizing a tailor. However, tailor-made clothing is usually more expensive than off-the-rack clothing items, may require a waiting time of several weeks, and is less accessible than shopping for off-the-rack clothing. Tailor shops specialized in men shirts and suits are not as ubiquitous as are average clothing stores. In addition, the process is less convenient as it may require several meetings to have a garment properly made. For many people, the process may be a less than comfortable one, as it involves a one-to-one relation with the tailor. All of these aspects may deter a potential customer from pursuing this option.

One conventional solution to this problem provides a remote, web-based “tailoring” service by which a customer can submit his body measurements online in accordance with instructional videos or web-site text, that is, by using a self-measurement system. These body measurements are used to produce a new article of clothing. However, unless the customer has used proper measurement techniques, the resulting product may not meet the expectations of the customer. Even if a correct measurement method is performed, the result can be greatly affected by interpretations and approximations introduced by personal techniques and skills.

For an example of interpretation in measurement, consider that the measurement of the arm length is usually understood to mean a measurement from the shoulder blade to the hand. Depending on the attaching point of the measurement, usually meant to be at the top of the shoulder, and the end point, usually meant to be at the mid-point on the back of the hand, there can be a variation of several inches, resulting in a complete unsatisfying fit.

For an example of approximation in measurement, consider that the method in which the measuring tape is placed on the body can affect the body measurement considerably. Especially for the large circumference measurements, such as the chest, the waist, and the hip, a few degrees of angle or tilt in the measuring tape can result in several inches of difference. Not even professional tailors can consistently place the measuring tape on the body twice in precisely the same position.

As a result of the hit-and-miss accuracy in measurement, a much bigger allowance is provided in the fit of the article of clothing made by the online custom made clothing producer, so as to ensure that the finished garment can accommodate the customer's body. That bigger allowance generally results in a much looser fit in garments produced by the remote, web-based “tailoring” service. Accordingly, these looser fitting garments, in many cases, are typically comparable with the fit of the off-the-rack garments.

An alternate conventional method requires the customer to submit an article of his clothing to a clothing service, where the clothing article is used as a template for producing a new, “made-to-measure” item. However, the new item is not likely to fit any better than the original customer article and would probably not meet the standards of a tailor-made product.

In another “method of tailoring,” a sales representative pays a personal visit to the client, obtains the required measurements, and passes the information to a remote tailor. However, this method implies that the personnel is professionally trained to provide quality measurements. If that is really the case, the final product price will have to consider the cost of the visit by a highly-trained professional and his sales commission. The result is that the final garment will be priced higher than other products of the same quality. Moreover, in case of a minimally-trained sales representative force, errors due to interpretation and approximation will most likely result, as per the self-measurement process described above.

What is needed is an inexpensive method of having made-to-measure and bespoke clothing produced at a lower cost, in a shorter time, and in a more convenient way than conventional methods may provide.

### BRIEF SUMMARY OF THE INVENTION

In one aspect of the present invention, a “fitting jacket” is created as an adjustable piece of clothing that allows a customer to define the best combinations of measurements for his personal comfort and style.

In another aspect of the present invention, an application is able to guide the customer through a process of taking pictures of himself to capture visual markers that correspond to key body measurements

In another aspect of the present invention, a system is created to receive and analyze those images. This system is able to automatically extract the relevant features from the images and translate them into precise measurements with an accuracy of within a quarter of an inch.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a diagrammatical illustration of a remote tailoring system used by a client for gaining access to a personal tailor, and for obtaining custom tailored high end clothing at reduced cost, in accordance with the present invention;

FIG. 2 is a photograph or digital image of the client upon initiating the process of acquiring a bespoke men's upper body garment;

FIG. 3 is a diagrammatical illustration of a profile page used by the client of FIG. 1;

FIG. 4 is a flow chart illustrating the sequence of operations followed by a client, a stylist, and a tailor in a remote tailoring method using the remote tailoring system of FIG. 1;

FIG. 5 is an illustration of a fitting jacket as worn by a client, showing a front panel and striped torso section, in accordance with the present invention;

FIG. 6 is a detail view of a marker on the fitting jacket of FIG. 5 and three anchor points on the front panel before client adjustment of the fitting jacket;

FIG. 7 is a detail view of a marker secured in the center anchor point after proper client adjustment of the fitting jacket of FIG. 5;

FIG. 8 is a detail view of a marker secured in the left anchor point resulting in an improper snug adjustment of the fitting jacket of FIG. 5;

FIG. 9 is a detail view of a marker secured in the right anchor point resulting in an improper loose adjustment of the fitting jacket of FIG. 5;

FIG. 10 is a detail view of a marker in one of three anchor points on the collar of the fitting jacket of FIG. 5;

FIG. 11 is a detail view of a marker and three anchor points on a cuff of the fitting jacket of FIG. 5;

FIG. 12 is a detail view of the cuff of FIG. 11 at the end of the fitting jacket sleeve;

FIG. 13 is a detail view of the cuff of FIG. 12 folded once over the sleeve;

FIG. 14 is a detail view of the cuff of FIG. 12 folded twice over the sleeve;

FIG. 15 is a view of a marker in one of three anchor points on the shoulder of the fitting jacket of FIG. 5;

FIG. 16 is a view of a linear fastener opening on the upper sleeve of the fitting jacket of FIG. 5;

FIG. 17 is a digital image of the client wearing the fitting jacket of FIG. 5;

and,

FIG. 18 is a web page used by the client for ordering a bespoke shirt via the remote tailoring system of FIG. 1.

### DETAILED DESCRIPTION OF THE INVENTION

The following detailed description is of the best currently contemplated modes of carrying out the invention, and is not to be taken in a limiting sense, but is made merely for the purpose of illustrating the general principles of the invention.

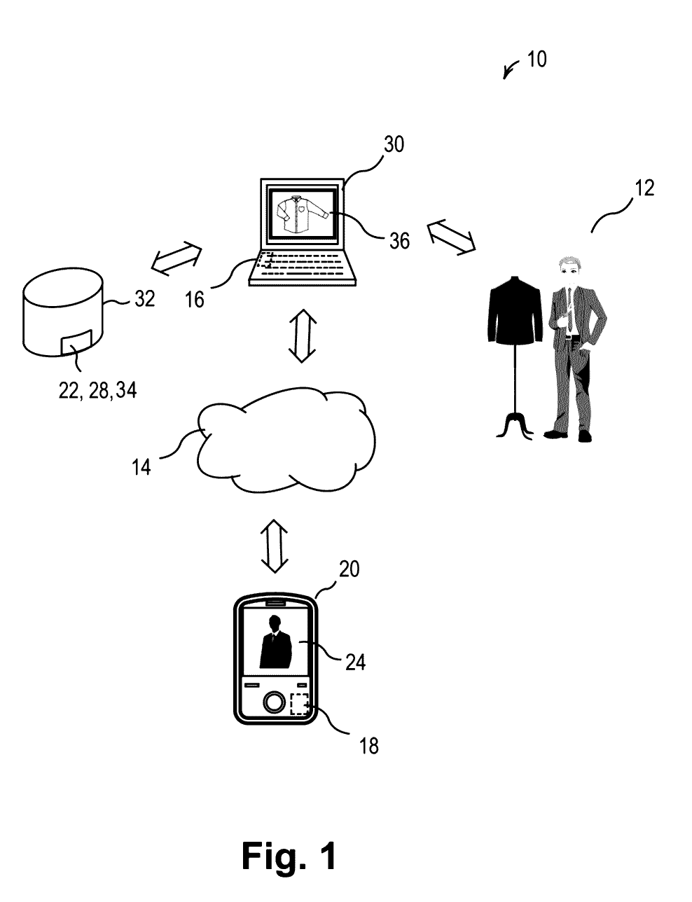

The disclosed method enables a client to obtain made-to-measure items of clothing ordered remotely, and at a smaller cost than would be incurred by the client patronizing a tailor shop. The method is conducted on-line by means of a remote tailoring system 10, shown in FIG. 1. The remote tailoring system 10 includes a wireless communication device 20, for example, used by the client in accessing the remote tailoring system 10, and a system computer terminal 30, used by an administrator of the remote tailoring system 10.

The remote tailoring system 10 enables a process by which certain client size and weight measurements for a desired garment can be provided by the client himself, the measurements to then be used by a remote system tailor 12. The client may use a client app 18 resident in his wireless communication device 20 to communicate with the system computer terminal 30 via the Internet 14. The administrator at the system computer terminal 30 may use a system app 16 resident in the system computer terminal 30 to access a client account 22 in a system server 32 as the client submits personal information so that the client may make an online request for a new, made-to-measure garment. The client may be provided with a video tutorial 34 from the system server 32 to explain the disclosed method, and to give the client directions on providing personal information and obtaining measurements for use by the system app 16.

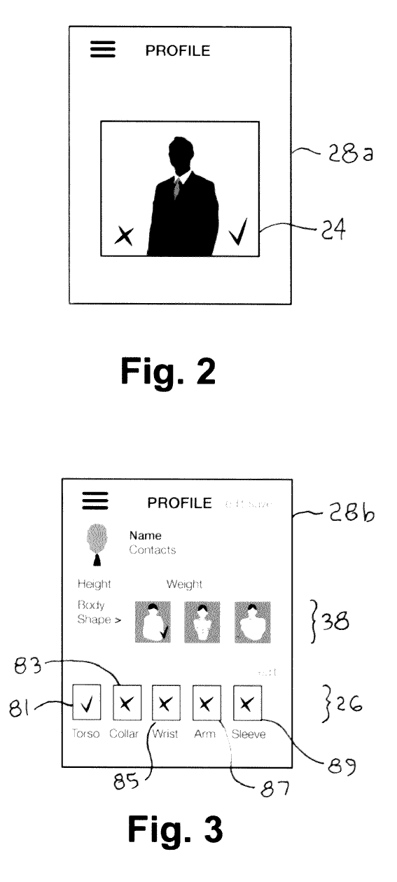

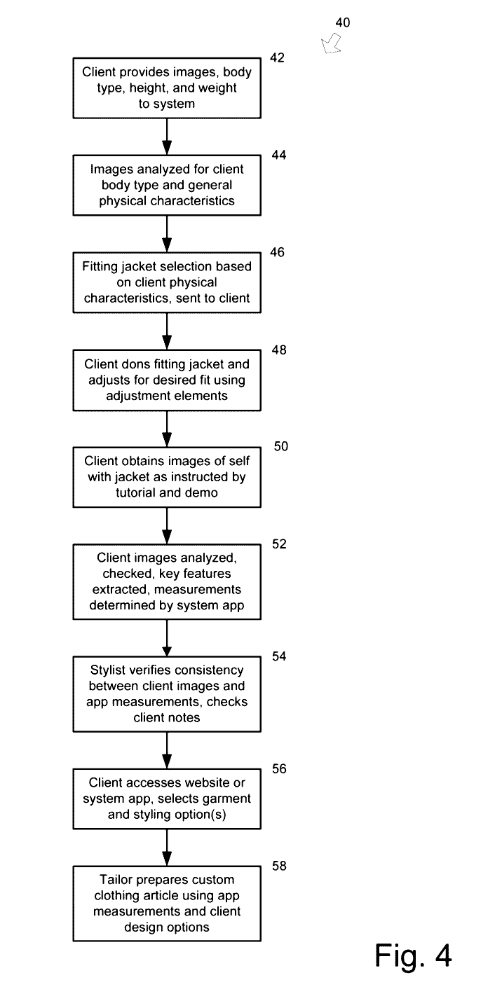

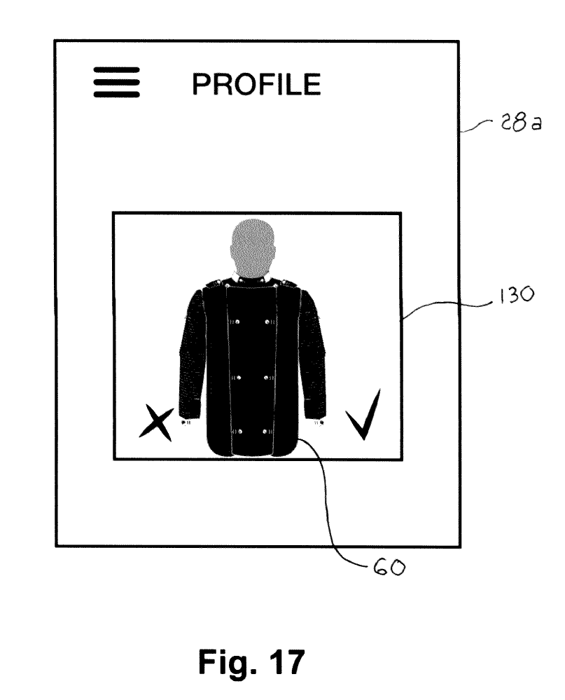

The method of the present invention requires that, prior to ordering a custom-tailored, high-end garment, a new customer (i) opens his client account 22, and (ii) submits a customer image 24 of himself for a profile page 28a, as shown in FIG. 2, using the client app 18. The customer image 24 can later be updated, or replaced by an image of the customer wearing a fitting jacket, as shown in FIG. 17 below. This initial customer image 24 can be used by the system administrator, or by the system tailor 12, to select the suitable fitting jacket (not shown). The customer may also provide height and weight information, as shown in another profile page 28b, shown in FIG. 3. The customer also specifies a body type, such as slender, short, average, athletic, tall, or portly, for example, by selecting one of the icons 38 provided as a reference, per step 42 of a flow diagram 40 shown in FIG. 4.

The system app 16 includes image recognition software, or a computer vision routine, which functions to analyze the submitted customer image 24, at step 44, for fitting characteristics, as described in greater detail below. Information provided in the profile, including the height, weight, and body type may also be taken into consideration by the system app 16. At a later time, the customer can enter specific digital images 26 of different views of his body as part of his profile page 28b, described in greater detail below.

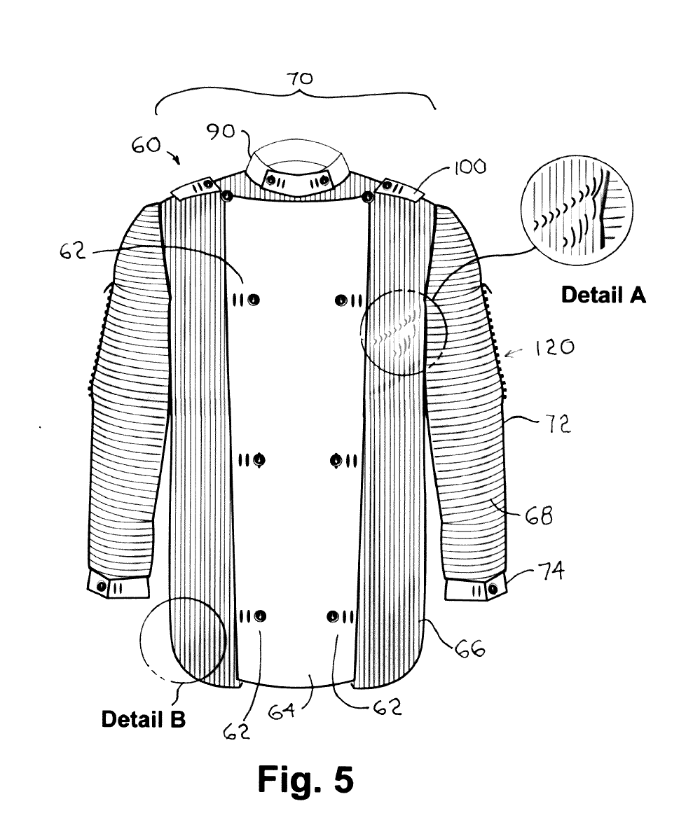

The analysis and measurements are used by the system app 16 to select and specify an appropriate fitting jacket 60 for the client, shown in FIG. 5. The fitting jacket selection process is based on the client's height, weight and body shape. The specified fitting jacket 60 is obtained from an existing supply of fitting jackets available to the system administrator, and is then sent to the client, at step 46. The dimensions and adjustment parameters of the selected fitting jacket 60 are also made available to the system app 16. These dimensions and adjustment parameters are obtained by the client after receiving the fitting jacket 60. This information is provided to the system app 16 and to the system tailor 12 by the series of digital images 26. The digital images 26 may include a torso image 81, a collar image 83, a wrist image 85, an arm image 87, and a sleeve image 89.

The concept of using the fitting jacket 60 is a product of a unique sizing system that has been based on and developed from over a hundred body shapes and sizes. By donning the fitting jacket 60, the client can use adjustment features to obtain body measurements that are automatically converted by the system app 16 into measurement data for the system tailor 12. These measurement data are substantially equivalent to measurements that the system tailor 12 would have obtained by measuring the client himself. Measurements obtained in accordance with the disclosed method, using the system app 16, have been verified to have an accuracy falling within a quarter of an inch of measurements that would have been physically obtained by system tailor 12.

As is generally the case, the fitting jacket 60 is a somewhat loose-fitting upper-body garment having a plurality of adjustment features or elements. These adjustment features and elements include: markers, anchor points, fasteners, and jacket indicia, features, and design attributes. Markers include moveable components used to physically adjust the fitting jacket 60 on a client. Anchor points are receptors used for selectively mating with a marker when adjusting the fitting jacket 60. Fasteners are fastening components that provide variable adjustment by the client to aid in properly fitting of the fitting jacket 60. Jacket features and design attributes include the fabric pattern(s) in the jacket material, any stretching or folding of the jacket material when worn, and the fitted appearance of the fitting jacket 60 while on the client. The markers, the anchor points, and the fasteners are provided in visually contrasting colors and/or patterns to enable an image analyzer to recognize the respective marker, anchor point, and fastener as imaged against the contrasting material of the fitting jacket 60.

The fitting jacket 60 comprises a front panel 64 depending from the client's neck to the waist, and extending across the chest of the client, as shown in FIG. 5. The fitting jacket 60 also comprises a torso section 70 which substantially conforms to a typical man's jacket with sleeves 72. The client is required to put on the fitting jacket 60 and to make adjustments using the front panel 64 and a plurality of adjustment features such that a desired fit of the fitting jacket 60 is achieved, at step 48.

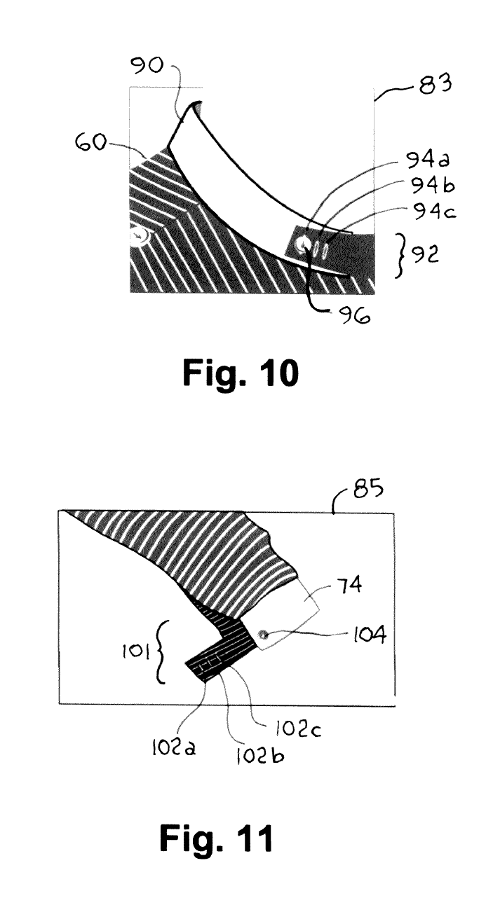

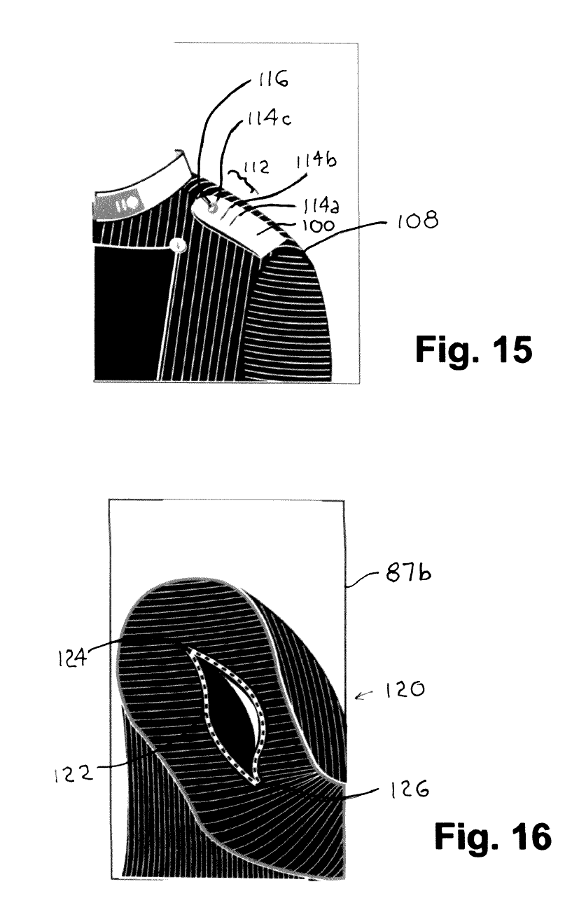

In an exemplary embodiment, the adjustment features include: (i) at least three pairs of marker sets 62 on the front panel 64. Two marker sets 62 provide client measurements of the chest, two marker sets 62 are used for the waist, and two marker sets 62 are used for the hip region; (ii) a marker set 92 (shown in FIG. 10) at the collar 90 of the torso section 70 to provide a client neck measurement; (iii) a marker set 101 on each sleeve cuff 74 to provide a client wrist measurement; (iv) a continuously-adjustable linear fastener 122 (shown in FIG. 16) along the upper part of the sleeves 72 to determine proper fit on the client's upper arm and biceps; and (v) marker sets 112 (shown in FIG. 15) along the shoulders 108 of the torso section 70 to establish proper fit at the client's shoulders. In addition, the sleeves 72 of the fitting jacket 60 can be distinctively rolled up at the cuffs 74 to determine a client sleeve length.

The fitting jacket 60 preferably includes a pattern of straight vertical parallel lines 66 on the torso section 70 of the fitting jacket 60, and a pattern of straight horizontal parallel lines 68 on the sleeves 72 of the fitting jacket 60. The parallel lines 66, 68 are used by the system app 16 to recognize the possibility that, if the parallel lines do not remain straight after the client has performed the necessary adjustments, the fitting jacket 60 may have been incorrectly adjusted by the client. For example, as shown in Detail A, folds may appear in the vertical parallel lines 66 in the torso section 70, indicating improper fit. Improper fit can also be inferred by the system app 16 from the presence of shadows and light regions, seen in Detail B.

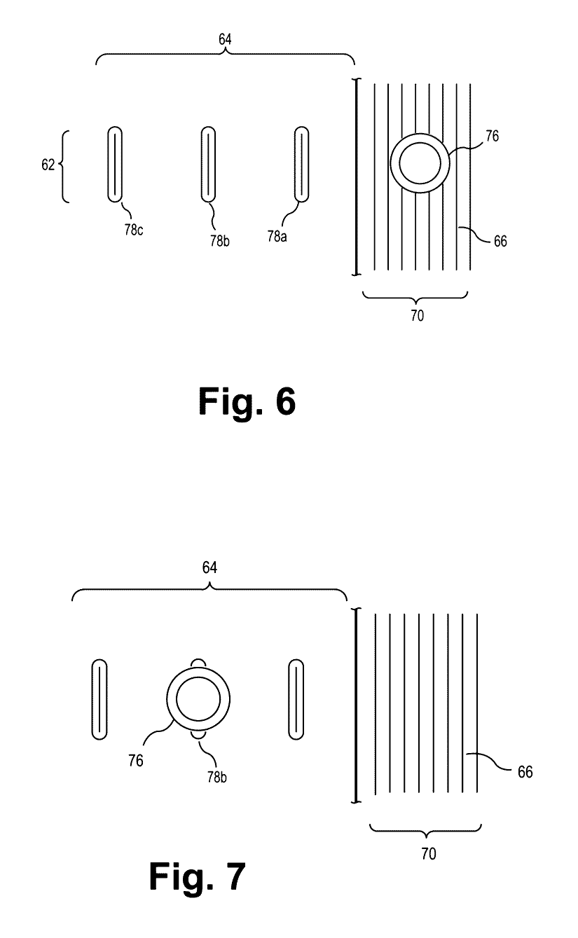

There is shown in FIG. 6 a detail view of the marker set 62 as disposed on the front of the fitting vest 60. In the example provided, the marker set 62 comprises a marker 76 and three anchor points 78a, 78b, and 78c. The marker 76 has the configuration of a button, but other geometries and shapes can be used. The anchor points 78a, 78b, and 78c are similar to buttonholes, although other geometries and shapes can be used. The marker 76 preferably includes surface markings and contrasting colors so as to stand out and be easily seen in the digital images obtained for analysis by the system app 16. The client performs the required adjustment by leaving the marker set 62 unfastened, or by fastening to one of the anchor points 78a, 78b, and 78c.

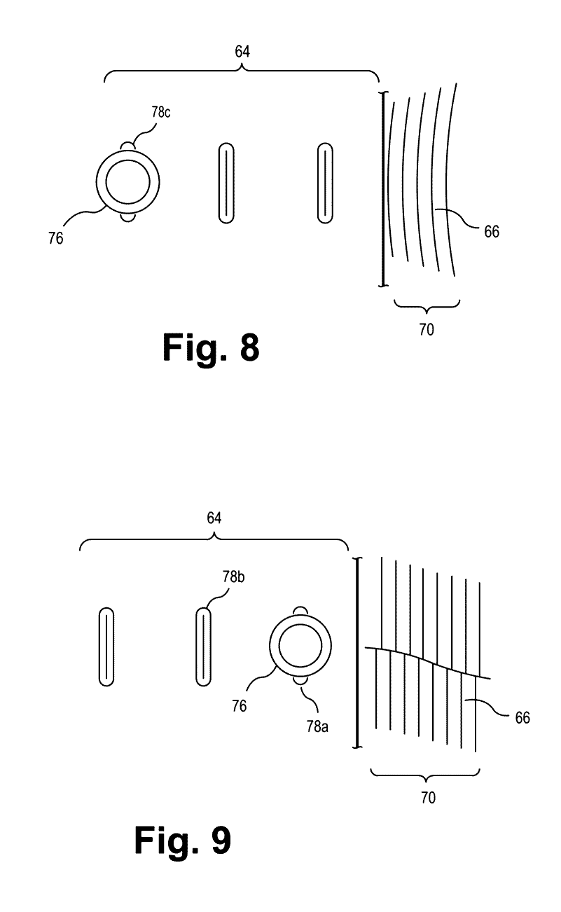

As shown in FIG. 7, the client has secured the marker 76 in the center anchor point 78b by moving the front panel 64 relative to the torso section 70. The vertical parallel lines 66 remain straight, indicating to the system app 16 that the client has most likely selected the correct anchor point 78b for his body size and measurement. In FIG. 8, the client has incorrectly adjusted the fitting jacket 60 by selecting the right anchor point 78c (as seen by the client) for securing the marker 76. As can be seen, the vertical parallel lines 66 are not straight, indicating to the system app 16 that fitting jacket 60 is too snug as the client has moved the front panel 64 too far to the right relative to the torso section 70. In FIG. 9, the client has again incorrectly adjusted the fitting jacket 60 by selecting the right anchor point 78a for securing the marker 76. As can be seen, the vertical parallel lines 66 are broken or offset, indicating to the system app 16 that folds are present in the fitting jacket 60, and that the fit is too loose.

A marker set 92 is shown disposed on the collar 90 of the fitting jacket 60, as recorded in the collar image 83, in FIG. 10. In the example provided, the marker set 92 includes three anchor points 94a, 94b, and 94c attached to a flap end of the collar 90, and a marker 96 provided in a second end of the collar 90. As shown in the illustration, the client has inserted the marker 96 into an anchor point 94a as providing a comfortable fit at his neck. Accordingly, the system app 16 automatically determines the neck size of the client by using image analysis to recognize that the marker 96 has been inserted into the left-most anchor point 94a, as seen in the collar image 83. This determination is based upon the dimensions and adjustment parameters of the fitting jacket 60 previously provided to the system app 16. Every fitting jacket 60 corresponds to a matrix of measurements so that, for any of the 2,125,764 combinations possible, there is a corresponding set of data.

A similar procedure is followed for a marker set 101 provided on the cuff 74 of the sleeve 72, shown in FIG. 11. The client determines into which anchor point 102a, 102b, or 102c to insert a marker 104. In this manner, after the customer has obtained the wrist image 85 with the client app 18, as shown in FIG. 11, the system app 16 can use image analysis to automatically determine the proper garment wrist size for the client.

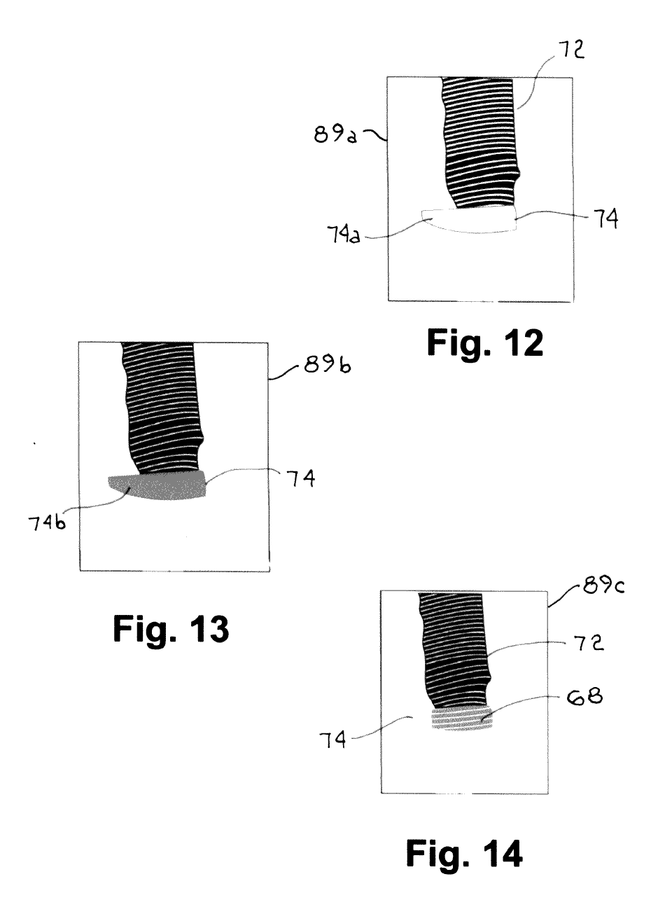

Sleeve length is determined by the appearance of the cuff 74 of the sleeve 72, as shown in FIGS. 12-14. In FIG. 12, denoted as a sleeve image 89a, the white outside surface 74a of the cuff 74 can be seen, indicating that the cuff 74 has not been folded over, and that the proper sleeve length for the client is a “long” sleeve length. It should be understood that the outside of the cuff 74 can be white, as shown, or another contrasting color, as determined by the maker of the fitting jacket 60.

In FIG. 13, denoted as a sleeve image 89b, the inside surface 74b of the cuff 74 can be seen, indicating that the cuff 74 has been folded over once, and that the proper sleeve length for the client is a “medium” sleeve length. It can be appreciated that the inside surface 74b of the cuff 74 has a different color or pattern from the outside surface 74a of the cuff 74 to enable the system app 16 to determine whether a once rolled-up condition exists.

In FIG. 14, denoted as a sleeve image 89c, the striped pattern of straight horizontal parallel lines 68 of the sleeve 72 can be seen at the bottom end of the sleeve 72, indicating to the system app 16 that the cuff 74 has been rolled up twice, and that the cuff 74 is now enclosed within the sleeve 72. Accordingly, in this example, after the customer has obtained the sleeve image 89c with the client app 18, for example, the system app 16 would determine that the proper sleeve length for the client is a “short” sleeve length inside the matrix of measurements linked to that specific fitting jacket.

FIG. 15 is an arm image 87a showing a shoulder 108 of the fitting jacket 60 with a marker set 112 comprising three anchor points 114a, 114b, and 114c on a flap 199 attached to the shoulder 108. A marker 116 has been secured in the left-most anchor point 114c of the flap 100. After the customer has obtained the arm image 87a of the shoulder 108 with the client app 18 as shown in FIG. 15, the system app 16 would use image analysis to determine which anchor point is being used, and to thus determine the proper shoulder size for the client.

The upper part of the sleeve 72 includes an upper arm adjustment feature 120 running along the upper sleeve 72, as shown in FIG. 16. In an exemplary embodiment, the upper arm adjustment feature 120 may comprise a linear fastener 122, such as a zipper, having pull tabs 124, 126 that contrast with the striped pattern of straight horizontal parallel lines 68 of the sleeve 72. As the pull tabs 124, 126 can be adjusted to positions from the ends of the linear fastener 122, the system app 16 can determine the amount by which the pull tabs 124, 126 are separated. After the customer has obtained the arm image 87b with the client app 18, as shown in FIG. 16, the system app 16 can determine the proper cut and size for the client dimensions for the upper sleeve of the custom-tailored, high-end garment expected by the client.

After all adjustments have been properly made, at step 48 above, the client is requested to take a series of images of himself wearing the adjusted fitting jacket 60, as instructed by the app tutorial 34 or by an demonstrational video (not shown), at step 50. The proper setup and framing of the digital images may be explained and illustrated in the tutorial and video. Alternatively, the client may ask a friend or an associate to obtain a fitting jacket image 130, as shown in FIG. 17.

In an exemplary embodiment, the client himself uses a digital camera (not shown) and the client app 18 to obtain one or more upper-body images wearing the fitting jacket 60 after it has been adjusted by the client. This series of digital images are sent to the system app 16 that analyzes and evaluates the digital images to yield a set of measurements for the client, at step 52. The system recognizes and extracts the essential measurement features, including the markers and used/unused anchor points, with an algorithm of computer vision. Then the system app 16 matches the marker positions to the measurement matrix that is related to the specific fitting jacket 60 being used, and extracts the correct set of body measurements.

In an exemplary embodiment, the system analyzes the lines 66, 68 on the fitting jacket 60 and shadows in the second digital image, as shown in FIG. 5, to identify non-standard conditions. If the system 16 determines that any of the markers 62, 76, 94, 104, or 116 are missing or hidden from view, the client may be requested to re-take the fitting jacket image 130. The system app 16 may also check the digital images for conformance to specified standards and notifies the client if any of the digital image(s) are not acceptable.

As a first example of a non-standard condition case, it can be appreciated that curved lines mean a snug or tight fit. If, as seen in the digital images, curved lines are present in relation to the fasteners, the system highlights the non-standard conditions in the admin panel and provides an alert to the system tailor 12 dedicated to the specific customer. As a consequence of the alert, the system tailor 12 may be seated at a computer screen to reach-out to the client, to double check if it is really the client's intention to be requesting a garment so snug. If the customer wants to adjust the fit to a looser setup, the client will be able to upload a new fitting jacket image 130 of himself as wearing the adjusted fitting jacket 60. The system tailor 12 will review the final option in the administration panel on the system terminal 30 and add/subtract an allowance that take into consideration wearability and other technical aspects.

As a second example of a non-standard condition case, it can be appreciated that broken lines also mean folds in the fabric implying a loose fit, as shown in Detail A in FIG. 5, and an excess of fabric near a datum point. If in the digital images it appears that some of the lines are broken, the system recognizes the non-standard conditions and highlights them in the admin panel. Again, the system tailor 12 verifies with the client the correct use of the fitting jacket and add/subtract allowance to the measurements. Looseness in the fabric may also produce changes of luminosity on the fabric as a consequence of ambient lighting on the client and the fitting jacket 60, as shown in Detail B in FIG. 5. The system recognizes these folds indicated by changes in luminosity and adjacent regions of shadows and bright spots, along any broken lines.

The size measurements, and the various digital images, may then be reviewed by the system tailor at the system terminal 30, for example, to have the results double-checked, and to provide any needed assistance to the client, at step 54. Client notes, if any, may also be reviewed by the system tailor.

An algorithm of machine learning is developed in the system app 16. Every time the system tailor 12 adds an adjustment allowance to a set of extracted measurements, especially in as a consequence of a non-standard condition, the system app 16 memorizes the adjustments and set them as a possible solution to any non-standard conditions of the same type. When statistically proved that the vast majority of similar cases are treated with the same adjustment the system will apply the allowances automatically and will keep that information in a change log in case the system tailor 12 wants to overwrite it.

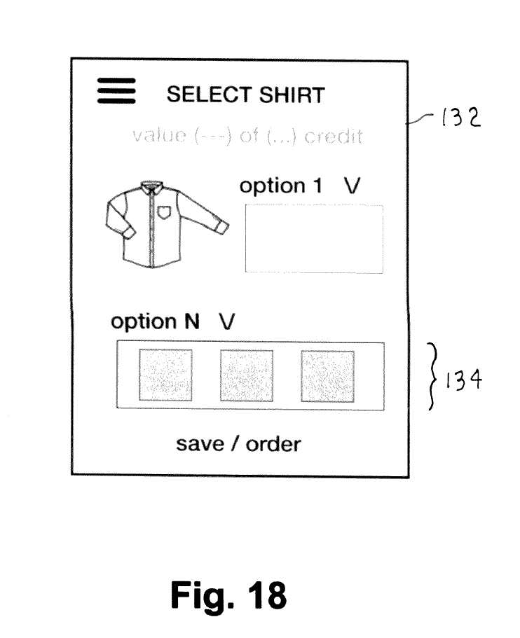

After the final measurements have been provided to the system tailor 12, the client may access a webpage 106 maintained by the remote tailoring system 10, at step 56. In FIG. 18, the client is viewing a man's shirt on the garment selection page 132. Using the garment selection page 132, the client can review and select style options 134 for a man's shirt. The system tailor 12 may then prepare the selected man's shirt for the client, based on the measurements derived by the system app 16 and the style options selected by the client, at step 58. Should a client incur a change of body measurements over time, the measurement process with the fitting jacket 60 can be repeated to update the measurements stored online in the client profile 28, and to replace the fitting jacket image 130.

It is to be understood that the description herein is only exemplary of the invention, and is intended to provide an overview for the understanding of the nature and character of the disclosed remote tailoring system and method. The accompanying drawings are included to provide a further understanding of various features and embodiments of the method and system of the invention which, together with their description serve to explain the principles and operation of the invention.

1. A method of remote tailoring for a client, said method comprising the steps of:
placing a fitting jacket onto the client, said fitting jacket including a torso and sleeves, said fitting jacket further including a plurality of adjustment features including markers and anchor points, said markers configured for insertion into adjacent said anchor points;
adjusting one or more of said adjustment features by selecting an anchor point to receive a corresponding said marker so as to provide a proper fit of said fitting jacket on the client;
producing a digital image of the client wearing said fitting jacket;
submitting said digital image to a system app, said system app functioning to obtain body measurements of the client by performing an analysis of said digital image to establish positions of said markers on said fitting jacket;
deriving client body measurements from said analysis of said digital image; and
providing said client body measurements to a remote tailor.

2. The method of claim 1 wherein each said sleeve comprises a zipper.

3. The method of claim 1 further comprising the step of determining improper fit of said fitting jacket by using analysis of parallel vertical lines on said jacket torso in said digital image.

4. The method of claim 3 wherein said step of determining improper fit of said fitting jacket comprises the step of recognizing a presence of at least one of a fold, a shadow, a curved line, and a light region in said parallel vertical lines.

5. The method of claim 1 wherein said jacket sleeve comprises a pattern of parallel horizontal lines.

6. The method of claim 1 further comprising the step of providing a video tutorial to the client, said video tutorial including an explanation of said method of remote tailoring.

7. The method of claim 1 further comprising the step of submitting a second digital image of the client to a system administrator for use in selecting said fitting jacket for the client.

8. The method of claim 1 wherein said step of adjusting one or more of said adjustment features comprises the step of adjusting one or more cuff adjustment features on a cuff of said fitting jacket.

9. The method of claim 1 wherein said step of adjusting one or more of said adjustment features comprises the step of adjusting one or more collar adjustment features on a collar of said fitting jacket.

10. A fitting jacket suitable for use in a remote tailoring method, said fitting jacket comprising:
a torso having a plurality of markers, a plurality of anchor points, and a first pattern of lines, each said marker configured for attachment to an adjacent said anchor point; and
at least one sleeve attached to said torso, said at least one sleeve including a second pattern of lines distinct from said first pattern of lines.

11. The fitting jacket of claim 10 wherein said fitting jacket further comprises at least three adjacent said anchor points for each said marker.

12. The fitting jacket of claim 10 wherein each said marker comprises a button, and each said anchor point comprises a button hole.

13. The fitting jacket of claim 10 further comprising a collar attached to said torso, said collar including at least one collar marker set configured to provide a client neck measurement, said at least one collar marker set including a collar button and at least three button holes.

14. The fitting jacket of claim 10 further comprising a sleeve cuff attached to said at least one sleeve, said sleeve cuff including a cuff marker set configured to provide a client wrist measurement, said cuff marker set including a sleeve button and at least three button holes.

15. The fitting jacket of claim 10 wherein said sleeve cuff comprises (i) an outside cuff surface having a pattern or color on said outside cuff surface distinct from a pattern or color on said sleeve, and (ii) an inside cuff surface having a pattern or color distinct from said pattern or color on said sleeve and distinct from said pattern or color on said outside cuff surface.

16. The fitting jacket of claim 10 further comprising a shoulder marker set on a shoulder of said fitting jacket, said shoulder marker set configured to provide an adjustment at said shoulder, said shoulder marker set including a shoulder button and at least three button holes.

17. The fitting jacket of claim 10 further comprising a continuously-adjustable linear fastener along an upper part of said at least one sleeve, said linear fastener configured to provide proper fit on an upper arm and bicep of the client.

18. The fitting jacket of claim 17 wherein said continuously-adjustable linear fastener comprises a zipper having a pull tab that contrasts with a pattern on said at least one sleeve.

19. A remote tailoring system suitable for enabling a client to acquire an item of clothing fabricated by a remote tailor, said system comprising:
a fitting jacket including a vertically-striped torso, at least one horizontally-striped sleeve, a plurality of torso markers on said torso, and a plurality of torso anchor points on said torso, said fitting jacket when worn by the client having each said torso marker fastened to a corresponding said torso anchor point;
a wireless communication device for acquiring a digital image of the client wearing said fitting jacket;
a system computer terminal in communication with said wireless communication device for receiving said digital image of the client wearing said fitting jacket, said system computer terminal including a system app functioning to perform at least one of: (i) obtaining fitting jacket measurements when worn by the client by analyzing locations of said torso markers on said fitting jacket, (ii) deriving client body measurements from said analysis of said digital image;
and (iii) providing said client body measurements to the remote tailor.

20. The remote tailoring system of claim 19 wherein said fitting jacket further comprises a pair of sleeves having a pattern of horizontal parallel lines, each said sleeve cuff having an outer surface pattern distinct from an inner surface pattern, each said sleeve cuff further including a cuff marker set having a button and at least three button holes.
